(19) United States
(12) Patent Application Publication
(10) Pub. No.: US 2016/0232347 A1
(43) Pub. Date: Aug. 11, 2016

(54) MITIGATING MALWARE CODE INJECTIONS USING STACK UNWINDING

(71) Applicant: Palo Alto Networks, Inc., Santa Clara, CA (US)

(72) Inventor: Gal Badishi, Tel Aviv (IL)

(21) Appl. No.: 14/616,780

(22) Filed: Feb. 9, 2015

(51) Int. Cl. G06F 21/56; G06F 21/55

(52) U.S. Cl. CPC G06F 21/56; G06F 21/55; G06F 21/562

(57) ABSTRACT

Malware in a computer is found by detecting a sequence of function calls in a memory space of a process executing on a computer, tracing the process stack to locate members of the sequence in a database of non-malicious function calls, failing to locate the sequence in the database, and responding to the failure by a combination of logging the failure, alerting an operator and terminating, blocking or otherwise disabling the process or a system call initiated by the process.

### BACKGROUND OF THE INVENTION

1. Field of the Invention

This invention relates to computer security. More particularly, this invention relates to malware detection and handling in a computer system.

2. Description of the Related Art

Malicious software, also known as malware, continues to increase in amount and sophistication, attacking a variety of operating systems, platforms, and devices. Current approaches for detection of malware include such techniques as filtering, heuristic analysis, signature and hash sum methods. None of these has been entirely successful.

For example, U.S. Pat. No. 8,935,791 proposes filtering a system call to determine when the system call call matches a filter parameter; making a copy of the system call and asynchronously processing the system call copy, if the system call does not pass through at least one filter, and the filter parameter does not match the system, placing the system call into a queue; releasing the system call after an anti-virus check of the system call copy, and terminating an object that caused the system call when the check reveals that the system call is malicious.

Malware running on a computer may inject its code into other processes, disguising its actions such that they appear to be originating from the injected (“trusted”) process. As a result of the disguise, the malware code may execute malicious actions that will be allowed by security systems if the affected process is whitelisted for a particular action, i.e., included on a list of trusted processes. Many of the conventional methods require the program to actually execute, at which time malware can inflict damage before it can be detected and neutralized.

### SUMMARY OF THE INVENTION

Embodiments of the invention detect disguised malware, inhibit the execution of the malware code at runtime, and thereby prevent destructive behavior. Generally speaking, malware can inject code into a process in two ways: as a legitimately-loaded, but malicious library, or as a dynamic allocation filled with opcodes and data. The operating system does not treat the second case as a loaded library. One method of detection is to insinuate user-mode malware detection code into processes that are being evaluated (not necessarily run by the user). Alternatively, user-mode and kernel-mode malware detection code may be introduced, and may interact or complement one another. Further alternatively, a hook or a callback function may be inserted into the kernel that can operate to detect the malware. The latter is preferable when permitted by the kernel, as it is less vulnerable to disruption by the malware. In one mode of operation, the malware detection code responds to events, for example, the creation of a process in suspended state.

One difficulty that is overcome by embodiments of the invention is the reality that potentially malicious actions by disguised malware code are actions that may have been legitimately invoked by the process. Distinguishing the two possibilities is achieved by a fine-grained analysis that identifies the piece of code that actually generated the particular action, i.e., whether the action was generated by legitimate code or by code of the intruder.

A response to detection of suspicious code may be handled in different modes of operations or combinations thereof: (1) logging or alerting to presence of the code; (2) inhibiting execution of functions and processes initiated by the code; and (3) deletion of the code.

There is provided according to embodiments of the invention a method for processing function calls, which is carried out by detecting a sequence of function calls in a memory space of a process executing on a computer, searching for the sequence in a database of non-malicious function calls, failing to locate a member of the sequence in the database, and responsively to the failure reporting an anomaly in the sequence.

Reporting an anomaly may include at least one of the following: logging the anomaly; causing an inactivation or termination of a thread of the process; causing a blockage of an event caused by an execution of the process or the thread; terminating the process; and alerting an operator.

According to an aspect of the method, searching for the sequence includes tracing a stack of the process to identify the members of the sequence therein.

According to still another aspect of the method, tracing the stack includes identifying respective return addresses in frames of the stack, and failing to locate the sequence includes determining that that the return address in one of the frames is anomalous.

According to an additional aspect of the method, tracing the stack includes identifying an order of the function calls in the sequence and determining that the order is anomalous.

According to yet another aspect of the method, detecting a sequence includes placing a hook onto a called function of the sequence and inserting stack analysis code into the computer, wherein the stack analysis code is activated by the hook.

According to yet another aspect of the method, the called function is immediately prior to a system call to a kernel function in the sequence.

According to another aspect of the method, the sequence of function calls includes a call to a system function that executes in a kernel memory of the computer, and detecting a sequence includes placing a callback function in the kernel memory, and triggering execution of the callback function upon an occurrence of an event caused by the call to the system function.

One aspect of the method includes placing a hook on the system function in kernel memory.

A further aspect of the method includes registering the callback function with a kernel that executes in the kernel memory.

Still another aspect of the method includes profiling activities of the computer by recording other sequences of function calls thereof, and accumulating the other sequences in the database.

There are further provided according to embodiments of the invention a computer software product and apparatus for carrying out the above-described method.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a system operative for mitigating malware code injections in accordance with an embodiment of the invention;

FIG. 2 is a diagram illustrating a layout of user-level process memory in a system affected by malware that is processed in accordance with an embodiment of the invention;

FIG. 3 is a set of diagrams comparing normal and anomalous process creation in accordance with an embodiment of the invention;

FIG. 4 is a diagram illustrating a layout of user-level process memory that is processed in accordance with an alternate embodiment of the invention;

FIG. 5 is a flow-chart of a method of malware detection in accordance with an embodiment of the invention;

FIG. 6 is a detailed flow chart illustrating the process of stack unwinding in accordance with an embodiment of the invention; and

FIG. 7 is a table illustrating a stack trace, which is evaluated in accordance with an embodiment of the invention.

### DETAILED DESCRIPTION OF THE INVENTION

In the following description, numerous specific details are set forth in order to provide a thorough understanding of the various principles of the present invention. It will be apparent to one skilled in the art, however, that not all these details are necessarily always needed for practicing the present invention. In this instance, well-known circuits, control logic, and the details of computer program instructions for conventional algorithms and processes have not been shown in detail in order not to obscure the general concepts unnecessarily.

Aspects of the present invention may be embodied in software program code, which is typically maintained in permanent storage, such as a computer readable medium. In a client/server environment, such software program code may be stored on a client or a server. The software programming code may be embodied on any of a variety of known non-transitory media for use with a data processing system, such as a USB memory, hard drive, electronic media or CD-ROM. The code may be distributed on such media, or may be distributed to users from the memory or storage of one computer system over a network of some type to storage devices on other computer systems for use by users of such other systems.

The program code may be provided to a processor of a general purpose computer, special purpose computer, or other programmable data processing apparatus to produce a machine, such that the instructions, which execute via the processor of the computer or other programmable data processing apparatus, implement the functions and acts specified herein.

### System Overview.

In the Microsoft Windows® operating system, and in several other operating systems, including those of mobile devices, there is a distinction between user-mode and kernel-mode code. Essentially, kernel-mode code (the Windows kernel) has unrestricted access to memory and to hardware resources generally. User-mode code includes user-application processes and processes initiated by the Windows kernel. User-mode code processes execute in respective exclusive virtual memory spaces and have restricted access to hardware resources. Thus one user-mode process cannot directly affect the memory of other user-mode processes, but has to do so indirectly by making a system call. Moreover, in order for a user-mode process to affect a hardware resource, a system call is made, e.g., a Windows API (Application Programming Interface) function call, which results in the processor switching from user mode to kernel mode as the API function executes, and switching back again when the API function returns.

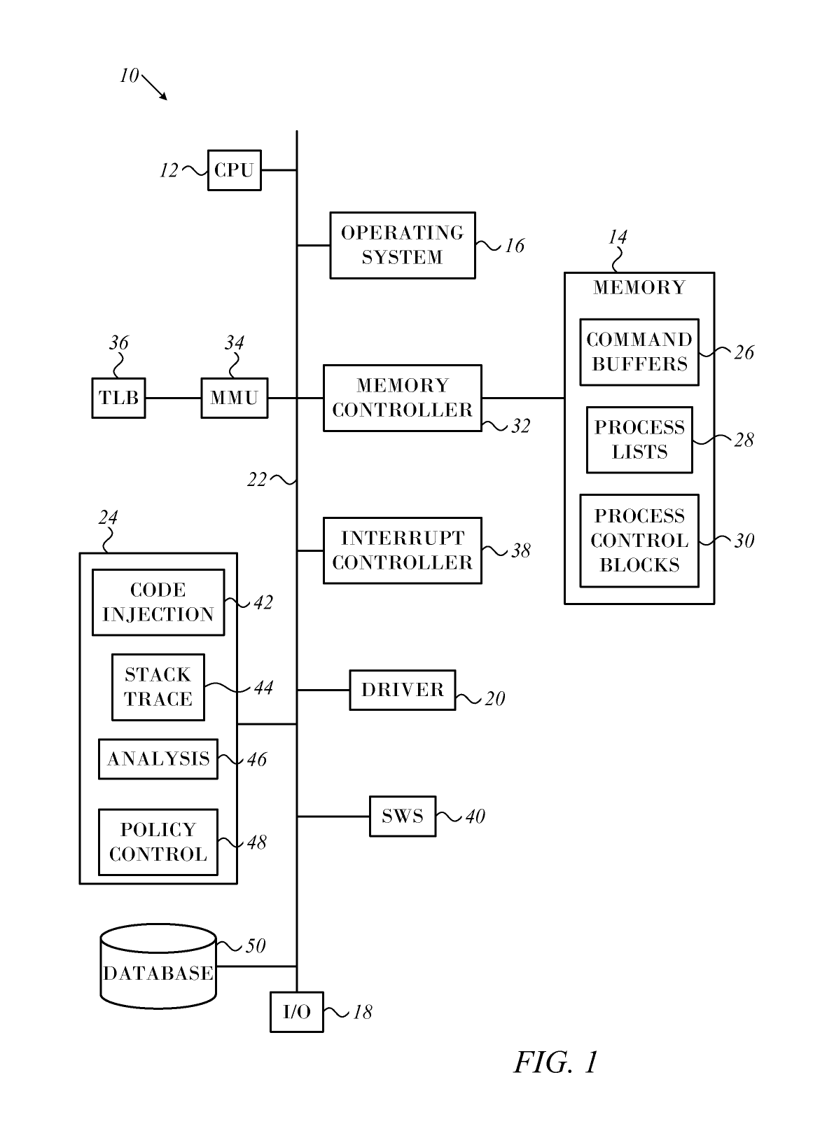

Turning now to the drawings, reference is initially made to FIG. 1, which is a block diagram of a portion of a system 10 operative for mitigating malware code injections in accordance with an embodiment of the invention. The system 10 is presented by way of example and not of limitation. The system 10 typically comprises a general purpose or embedded computer processor, which is programmed with suitable software for carrying out the functions described hereinbelow. Thus, although portions of the system 10 shown in FIG. 1 and other drawing figures herein are shown as comprising a number of separate functional blocks, these blocks are not necessarily separate physical entities, but rather may represent, for example, different computing tasks or data objects stored in a memory that is accessible to the processor. These tasks may be carried out in software running on a single processor, or on multiple processors. Alternatively or additionally, the system 10 may comprise a digital signal processor or hard-wired logic.

A central processing unit CPU 12 can include one or more single or multi core

CPUs. The system 10 includes a memory 14, an operating system 16 and may include a communication interface 18 (I/O). One or more drivers, represented by driver 20 communicates with a device (not shown)) typically through bus 22 or communications subsystem to which the device connects. Additionally or alternatively, the drivers may extend capabilities offered by the operating system. The extended capabilities are not necessarily related to a particular physical device. Such drivers may run in user mode or kernel mode.

The CPU 12 executes control logic, involving the operating system 16, applications 24 and may involve the driver 20.

The memory 14 may include command buffers 26 that are used by the CPU 12 to send commands to other components of the system 10. The memory 14 typically contains process lists 28 and other process information such as process control blocks 30. Access to the memory 14 can be managed by a memory controller 32, which is coupled to the memory 14. For example, requests from the CPU 12, or from other devices to access the memory 14 are managed by the memory controller 32.

Other aspects of the system 10 may include a memory management unit 34 (MMU), which can operate in the context of the kernel or outside the kernel in conjunction with other devices and functions for which memory management is required. The memory management unit 34 normally includes logic to perform such operations as virtual-to-physical address translation for memory page access. A translation lookaside buffer 36 (TLB) may be provided to accelerate the memory translations. Operations of the memory management unit 34 and other components of the system 10 can result in interrupts produced by interrupt controller 38. Such interrupts may be processed by interrupt handlers, for example, mediated by the operating system 16 or by a software scheduler 40 (SWS).

Among the applications 24 are modules that execute functions that are described below. These modules include a code-injecting module 42, stack-trace module 44, stack-trace analysis module 46, and a policy control module 48, which determines the system's response to attempted activities by anomalous processes. Database memory 50 holds data relating to known modules and process activities.

### Malware Detection.

The process of malware detection and inhibition is explained for convenience with respect to versions of the Microsoft Windows operating system. The principles of the invention are also applicable, mutatis mutandis, to many other operating systems and platforms.

Malware usually injects itself into legitimate processes, where it hides malicious behavior, and implicitly becomes whitelisted, and can use the privileges of the legitimate processes for its own purposes. The processes described herein evaluate actions that are about to be taken by a process, but which have not yet occurred. Performance of the processes identifies the originator of such actions at a granularity that goes beyond identification of the originating process, and extends to modules within the process and even to particular functions within the modules. Specific identification at such a fine-grained level is a basis for determining whether an impending action is a legitimate process action or not with a high degree of accuracy.

### First Embodiment

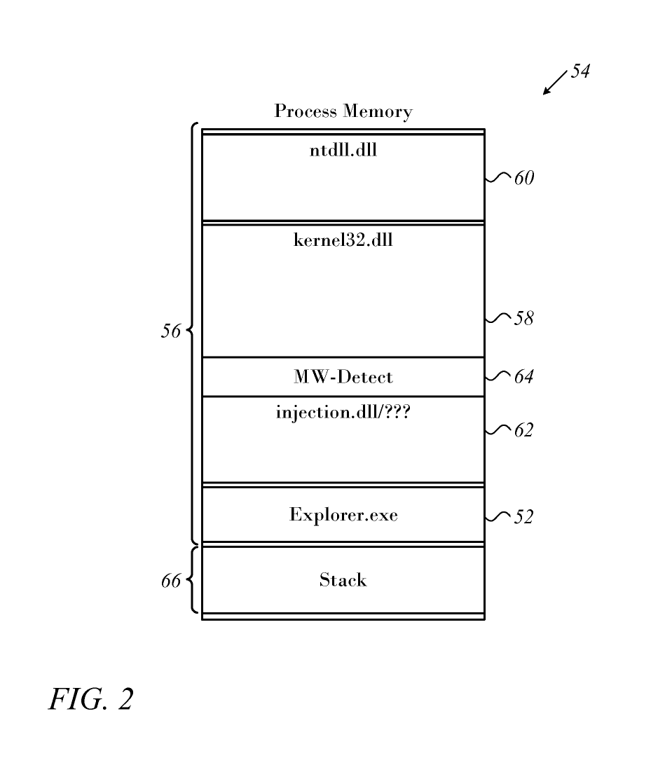

Reference is now made to FIG. 2, which is a diagram illustrating a layout of user-level process memory in a system affected by malware that is processed in accordance with an embodiment of the invention. Explorer.exe 52 is a typical module, which runs within its own exclusive virtual address space 54. The virtual address space typically comprises several types of content:

A segment 56 contains executable code. This part of the virtual address space contains machine code instructions to be executed by the processor, such as dynamically linked system libraries 58, 60 (kernel32.dll and ntdll.dll). Such library code is often write protected and shared among processes. It will be noted that the segment 56 contains malware in the form of injected code 62. Another segment comprises malware detection code 64 (MW-DETECT), which has been instantiated in the address space 54 and is explained in further detail hereinbelow.

A stack 66 is used by the process for storing items such as return addresses, procedure arguments, temporarily saved registers or locally allocated variables. Other segments (not shown) of the process memory address space 54 contain static data, i.e., statically allocated variables to be used by the process, and the heap, which contains dynamically allocated variables to be used by the process.

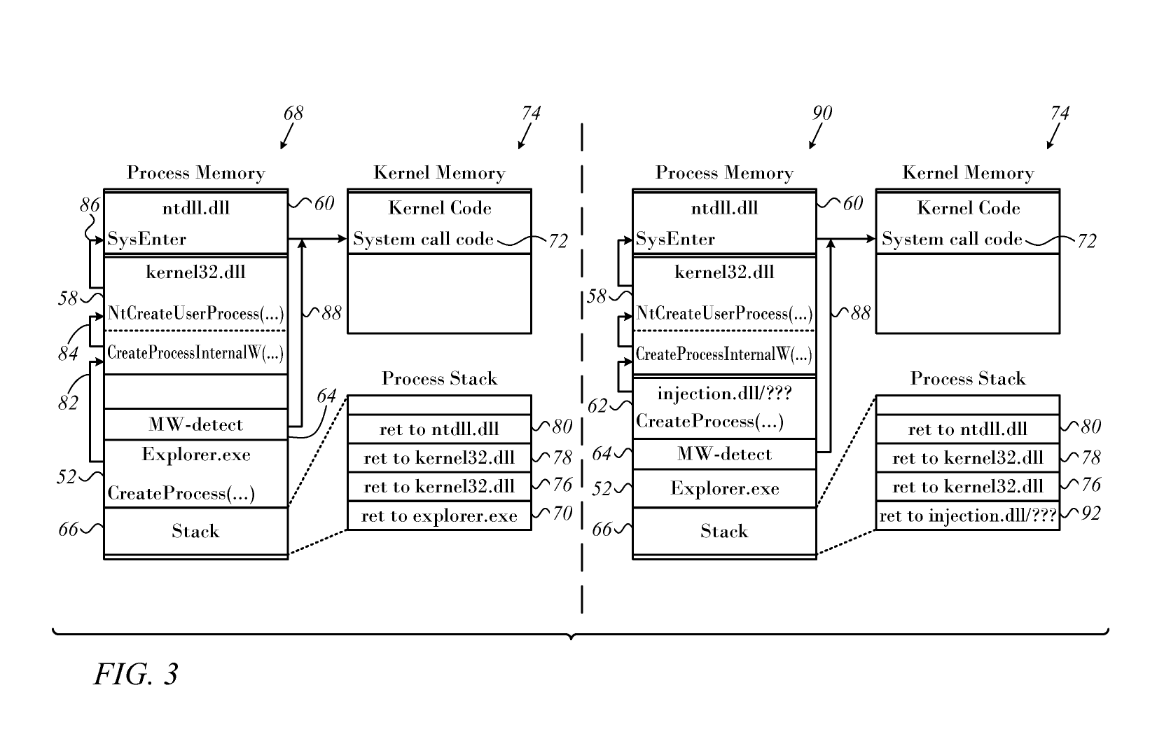

Reference is now made to FIG. 3, which is a set of diagrams comparing normal and anomalous process creation in accordance with an embodiment of the invention. Application process memory 68 is shown in the example at the left of FIG. 3. The module explorer.exe 52 issues a call to a kernel function CreateProcess( ). Accordingly, frame 70 is pushed onto the stack 66, and includes a return address to explorer.exe 52. In the x86 architecture the current position in the stack is maintained by the esp register, while the position of the beginning of the last stack frame is typically saved in the ebp register. Invocation of the Windows API function CreateProcess( ) results in calls to the internal system function CreateProcessinternalW( ), the internal Windows function NtCreateUserProcess( ) and the command sysenter in library 60, Execution of the command sysenter causes the processer to switch to kernel mode in order to execute the relevant system call, i.e., process creation in this example. Thereafter, there is an invocation of a system function 72 in kernel memory 74. The calls made from the process memory 68 are reflected in return addresses to the library 58, and the return address to library 60 in stack frames 76, 78, 80. The call pattern and the identity of the modules associated with the return addresses can be elucidated by a trace of the stack 66. Such a stack trace identifies the order of invocation indicated by arrows 82, 84, 86, respectively, and in particular would ultimately identify explorer.exe 52 as the originator of the sequence.

In the example of FIG. 3, malware detection code 64 intercepts the Windows API calls used by explorer.exe 52, library 58 or library 60 in order to perform an algorithm that accomplishes the above-mentioned stack trace and includes its evaluation. The interception, known as a “hook” occurs before the function in kernel memory 74 is invoked. Placing the hook immediately prior to the entry into kernel memory 74 (as shown by arrow 88) is preferable, as it is least subject to disruption by sophisticated malware.

A typical malware detection hook redirects the callers of the hooked function to a different piece of code, which, in the case of user mode hooks, was inserted into the same process prior to the hook being placed. That piece of code handles malware detection logic, which is applied whenever the hooked function is called.

Several techniques for injecting hooks into process memory in order to intercept Windows APi calls are known. One method involves calls to the APi functions LoadLibrary( ) and WriteProcessMemory( ). Another method comprises injecting code from the kernel directly into the process, and then running the injected code, which includes user mode calls, e.g., the API functions LoadLibrary( ), GetProcAddress( ) and optionally VirtualAlloc( ). Alternatively, equivalent code may be run directly from the kernel. The details of these hooking procedures are not discussed further herein. There are several places in a function in which a hook can be placed. For example, it can be placed on the function itself (mostly at the beginning, but could also be later or at the end), on a sub-function that the main function is calling. Yet another method involves import-table redirection.

The diagram at the right of FIG. 3 illustrates a case in which malware has injected code 62 into process memory 90. The stack frames have the same order as in the previous case, except that stack frame 92 replaces frame 70. While frame 70 included a return address pointing to explorer.exe 52, frame 92 has a return address pointing to injected code 62. The anomaly in the stack frames and the identity of its originator may be revealed by analysis of the stack trace described above.

### Second Embodiment

In the previous embodiment, the hook was implemented in user application memory. A more secure approach is to place callback function code in kernel memory and register the callback function with the operating system with respect to an event that needs to be examined. Upon triggering of such an event the kernel will execute the callback function registered for that event, and may produce a notification of the event and/or a notification of the execution of the callback function. This approach eliminates the need for a hook.

Alternatively, hooks to a system call can be instantiated directly into the kernel; however this requires the kernel to permit kernel memory modifications, and not all kernels extend such permissions.

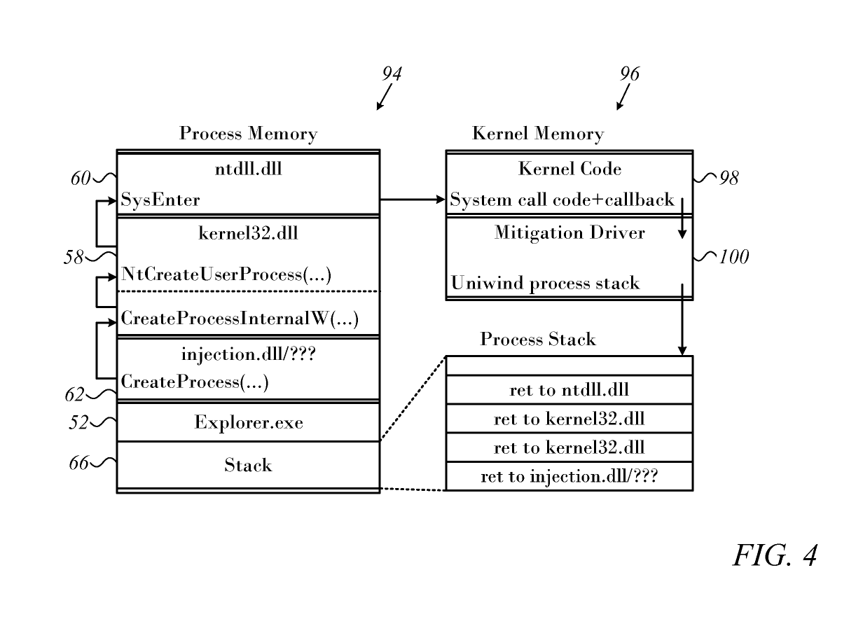

Reference is now made to FIG. 4, which is a diagram illustrating a layout of user-level process memory that is processed in accordance with an alternate embodiment of the invention. The layout of process memory 94 and the sequence of function invocation is similar to process memory 90, except that the malware detection code is omitted from the process memory 94.

Kernel memory 96 contains a call to a system function 98 dictated by the library 60 and to a callback function that was registered with the kernel and inserted. The callback function relates to mitigation driver 100, which performs the algorithm noted in the description of the malware detection code 64 (FIG. 3).

### Operation.

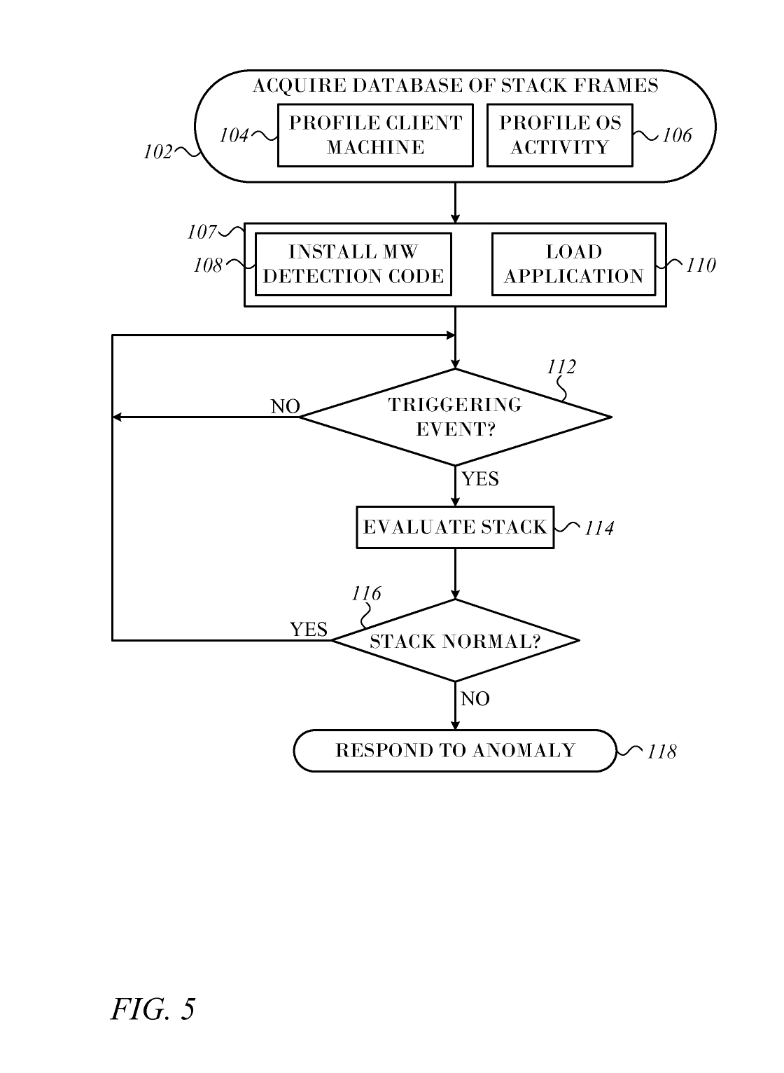

Reference is now made to FIG. 5, which is a flow-chart of a method of malware detection in accordance with an embodiment of the invention. The process steps are shown in a particular linear sequence for clarity of presentation. However, it will be evident that many of them can be performed in parallel, asynchronously, or in different orders. Those skilled in the art will also appreciate that a process could alternatively be represented as a number of interrelated states or events, e.g., in a state diagram. Moreover, not all illustrated process steps may be required to implement the method.

Initial step 102 comprises profiling the operation of the system being evaluated or monitored for the presence of software. The profile procedure results in a database of stack traces, which are known to be the results of legitimate operation of system software. Initial step 102 may comprise, in any combination, step 104, which is an analysis of a particular installation having a controlled list of applications running under a known operating system (OS) and step 106 in which a profile of operations by the operating system on one or more computers is acquired, not necessarily the computers of the particular installation. In step 106 the software executing on the computers is not controlled. The profile may include symbols. Such symbols may exist in the code itself or can be obtained from symbol files, e.g., pdb files, which map statements in the source code to the instructions in the executables. The symbols enable the source of the stack trace to be obtained with greater particularity than the process name or module name. When symbols are available, the actual function within a module can be identified, and the stack trace characterized in greater detail than would otherwise be possible. The profile may be updated continually or periodically, on-line or off-line. The update may be done automatically or interactively by an operator, The updated versions can be employed in the steps described below.

Step 104 produces a more directed database than step 106. Additions or deviations from the stack traces in the database are likely to be less frequent and more significant. However, even when the installation computers are unavailable or the installation computers are available but their software is not controlled, performance of step 106 can still provide a sufficiently large database to enable reporting the presence of malware with a practical confidence level. Step 104 may be performed continually in order to increase the quality of the database and to adjust to changes in the operating system and the computing environment generally. While the database is primarily designed for recognition of legitimate operations, it may include a data set that characterizes stack traces known to be illegal, i.e., indicating the presence of malware.

In one database, an exemplary whitelisted record includes:
1) Event type (e.g., creation of a new process in a suspended state);
2) Source process, i.e., the process initiating the event, e.g., explorer.exe, or “*” for all processes);
3) Source module, i.e., the module that initiated the event inside the source process. This could be a library name, the name of the executable file, e.g., explorer.exe, or “*” for all modules inside the source process); and
4) Target of event, e.g., the name of the created process, e.g., notepad.exe, or “*” for all processes.

It will be evident that this record allows many stack trace variants to be cleared without further action by the malware detection system.

In some embodiments, the database may be more extensive than the preceding example, making it useful for further analysis of stack traces that are not whitelisted. it may be organized in any manner, within one database or as a complex of relational databases. information in an extended database of this sort may include symbol information, and the details of the flow, i.e., the internal order of the function invocations, expected parameter values and/or relations thereof. The use of this sort of database is applicable whether user-mode or kernel-mode techniques are being employed.

Once initial step 102 has been accomplished control passes to block 107, which comprises step 108 and step 110. The order of these two steps varies according to whether kernel mode callback function or kernel hooking is being registered, a procedure that needs only to be done once, or whether user-mode hooking is employed. in the case of user-mode hooking, step 110 is performed first. The process is created, and then the detection code is placed in step 108. in the case of kernel mode techniques, step 108 may precede step 110.

At step 108 malware detection code is installed for the process. Step 108 normally needs to be performed only once when the detection code is in kernel-mode, and applies to all processes thereafter. The configuration normally automatically reloads even after a reboot. Step 108 may be performed using either of the embodiments described above. For example, a callback function may be registered with the operating system, and may be triggered by events resulting from different processes that invoke the kernel function, but it can be tailored to respond only to selected processes.

At step 110 an application is loaded in a computer being monitored. The application may be a user application or a system program operating in a user mode. in any case the application is assigned a process workspace by the operating system.

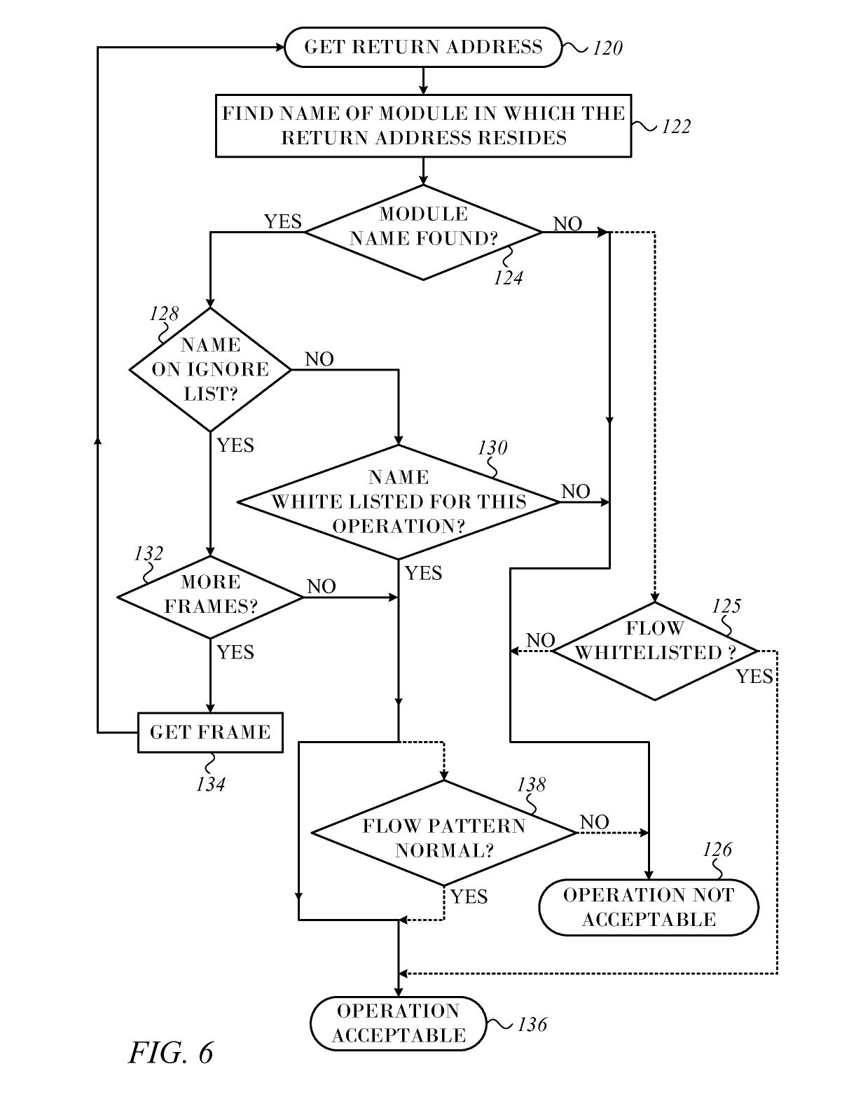

Upon exiting block 107 delay step 112 occurs. Nothing further occurs until a triggering event occurs. The event can be invocation of a function such that the hook operates or a registered event occurs and the callback function executes, as the case may be. Then, at step 114 the malware detection code that was placed at step 108 executes and a stack trace is executed and analyzed, using conventional stack tracing methods. The details of the stack trace and analysis are explained below in further detail in the discussion of FIG. 6. The actual procedure varies according to the calling conventions used by the operating system of the computer being assessed. For example, it is common in 32-bit versions of Windows for the stack frame to push the position of the beginning of the last stack frame from the ebp register onto the stack and then replace it with the contents of the esp register. in the 64-bit version this is not usually done; rather each executable or library file contains stack unwinding information for all of the functions defined within it.

Next, at decision step 116, it is determined if the stack trace can be regarded as non-threatening. As explained below, this is the case either if the stack trace appears on a whitelist, i.e., a list of known combinations that are known to be innocuous, or all the frames of the stack appear on an ignore-list of modules known to execute safe operations. if the determination is affirmative then control returns to delay step 112 to await a new event.

If the determination at decision step 116 was negative, the anomaly detected in step 114 is treated in accordance with a governing policy, which may dictate alerting the operator that a possible intrusion has occurred. Alternatively, the process may be blocked, suspended, killed or caused to be killed or blocked indirectly, e.g., by terminating the thread that would perform the malicious action. Alternatively, the effects of the process may be directly or indirectly blocked, e.g., by killing a child process or causing it to be ineffective. Except when the event is merely being logged, performance of final step 118 prevents the system call in kernel memory from executing or otherwise disables its effect, This can be done by preventing the system call from executing, e.g., by blocking its invocation, by modifying parameters so that the operation will be cancelled, or by executing a different operation in parallel that will negate the effects of the attempted operation.

Reference is now made to FIG. 6, which is a detailed flow chart illustrating the process of stack unwinding and evaluation of step 114 (FIG. 5) in accordance with an embodiment of the invention. As previously noted, the process steps described need not be performed in the order presented.

At initial step 120 the user-mode return address, in accordance with the current user-mode stack frame and calling sequence, is retrieved from the stack. The initial return address may be retrieved from other user-mode context information, such as the instruction pointer register.

The name of the module in which the return address resides is then retrieved at step 122. The details are operating system-dependent, as noted above.

Next, at decision step 124, it is determined if the module name was found at step 122.

Failure to retrieve the module name is a significant indication that intrusive code may be present. An unexpected module name is another such indication. For example, the originating code may not be part of a legitimately loaded library.

In any case, when the determination at decision step 124 is negative then an optional decision step 125 may be performed in order to detect false results in decision step 124. When decision step 125 is not performed the procedure ends at final step 126, and the anomaly is reported.

At optional decision step 125 it is determined if the flow is whitelisted. If the determination is affirmative, then the operation is in fact acceptable, and control proceeds to final step 136.

If the determination at decision step 125 is negative, then the operation is not acceptable and control proceeds to final step 126.

If the determination at decision step 124 is affirmative, then a process of stack unwinding begins. This comprises a stack walk of the process' stack. The function return addresses encountered at each frame are checked. Thus, the entire chain of calls that triggered the event is revealed.

Control proceeds to decision step 128 where it is determined if the module name found in step 122 is on the ignore-list. If not, then control proceeds directly to decision step 130, which is described below.

If the determination at decision step 128 is affirmative, then at decision step 132, it is determined if more stack frames remain to be evaluated.

If the determination at decision step 132 affirmative, no further action is required for the current frame. Control proceeds to step 134. The next frame is obtained in order to continue the stack trace. Control then returns to initial step 120 to begin a new iteration.

When no more frames remain at decision step 132, then in some embodiments the stack trace ends at final step 136. It is concluded that the flow is not suspicious and the operation is acceptable.

However, in some embodiments control proceeds to an optional decision step 138 where it is determined if the pattern of invocations in the flow correspond to a known or expected order. An analysis of the flow pattern to make this determination may include evaluation of the order of invocations, and the pattern of the function calls, including the function parameters and relationships among the parameters. For example, a set of parameters that do not conform to a known set of ranges may cause an alert. Detection of an unusual calling convention provides yet another clue to the presence of malware, e.g., the ebp register was not pushed as expected. If the determination at decision step 138 is affirmative, then it may be concluded that the sequence of invocations was legitimate, and control proceeds to final step 136.

If, at decision step 128 the module name was not found on the ignore-list, then a whitelist database is examined. At decision step 130, it is determined if the name of the module is whitelisted for the action being attempted.

If the determination at decision step 130 is negative, then control proceeds to final step 126, and an anomaly is reported.

If the name of the module is whitelisted, and the determination at decision step 130 is affirmative, then control proceeds to optional decision step 138 or final step 136.

### Example

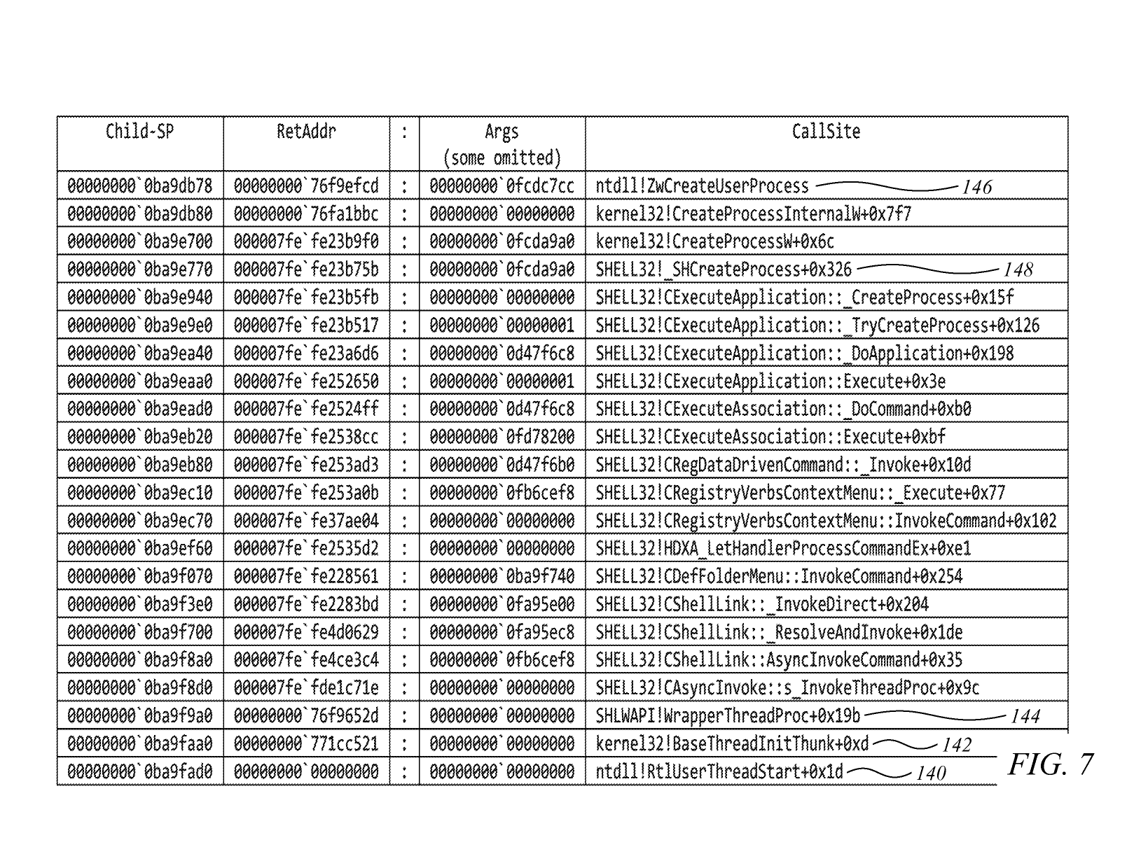

This example illustrates detection and analysis of the creation of a new process. Reference is now made to FIG. 7, which is a table illustrating a stack trace prepared using the 64-bit version of the Windows operating system and which is evaluated in accordance with an embodiment of the invention. In the table some of the arguments have been omitted for clarity. The right column has the syntax:

module name ! function name”.

Entries in the right column containing the notation “::” indicate the syntax:

“class::function (method)”.

Exact function names are used. The symbol information is readily available for Windows system DLL (dynamic linked library) files, some of which appear in the presented trace. In the case of the 64-bit version of Windows, information about how to unwind the stack is saved in the 64-bit executable file itself as part of the file format.

The bottom line 140 of the table presents the first function that was called, RtlUserThreadStart, which is in the ntdll library. As shown in line 142 next above, that function called the function BaseThreadlnitThunk in the kernel32 library. That function in turn called the function WrapperThreadProc in the module SHLWAPL as shown in line 144, etc. The function, ZwCreateUserProcess from the module ntdll, shown in line 146, represents the last function in user-mode before the transfer to kernel mode.

Normally, only the user mode stack is examined. It is unwound in realtime at step 114 in the method shown in FIG. 5, and the function ZwCreateUserProcess is the first function typically encountered. Assuming ntdll.dll is on an ignore-list, unwinding the stack continues, each successive entry being checked against the database entries comprising the ignore-list. Of course, when symbol information is not available, the process may still be implemented, but only the module names and sometimes limited function information, e.g., ntdll can be searched in the database.

The process of unwinding the stack continues with successive entries until the end of the stack is reached. This occurs if all the modules and all the functions are on the ignore-list.

The process stops earlier under certain circumstances, for example when a module is not found in the ignore-list. Assuming that the ignore-list contained only the modules ntdll and kernel32.dll, then the stack trace will halt at line 148, where the module SHELL32 would need further evaluation because it is not in the ignore-list. The further evaluation may comprise determining whether the source process, the source module and the target process is found in the whitelist database. Additionally or alternatively the evaluation may involve analysis of the entire stack trace as so far determined and not just the name of the originating module.

The stack trace will halt if the current module's name cannot be determined. This occurs if the module was not properly loaded. In such case a numerical address would appear instead of the module's name. Either of the two last cases are abnormal and would produce an anomaly that, if not found to be whitelisted in optional decision step 125, is handled in step 118 (FIG. 5). Reaching the end of the stack prematurely, or via an incorrect flow in the unwinding process may constitute another abnormal state, which is then handled in step 118. The end of the stack is recognized when no more return addresses remain to be popped from the stack.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for processing function calls, comprising the steps of:
detecting a sequence of function calls in a memory space of a process executing on a computer, the sequence having members
searching for the sequence in a database of non-malicious function calls;
failing to locate one of the members in the database; and
responsively to failing to locate reporting an anomaly in the sequence.

2. The method according to claim 1, wherein reporting an anomaly comprises logging the anomaly.

3. The method according to claim 1, wherein reporting an anomaly comprises causing at least one of: an inactivation or a termination of the process, an inactivation or termination of a thread of the process; and a blockage of an event caused by an execution of the process or the thread.

4. The method according to claim 1, wherein reporting an anomaly comprises alerting an operator.

5. The method according to claim 1, wherein searching for the sequence comprises tracing a stack of the process to identify the members of the sequence therein.

6. The method according to claim 5, wherein tracing the stack comprises identifying respective return addresses in frames of the stack, and failing to locate comprises determining that that the return address in one of the frames is anomalous.

7. The method according to claim 5, tracing the stack comprises identifying an order of the function calls in the sequence and failing to locate comprises determining that the order is anomalous.

8. The method according to claim 1, wherein detecting a sequence comprises placing a hook onto a called function of the sequence and inserting stack analysis code into the computer, wherein the stack analysis code is activated by the hook.

9. The method according to claim 8, wherein the called function is immediately prior to a system call to a kernel function in the sequence.

10. The method according to claim 1, wherein the sequence of function calls comprises a call to a system function that executes in a kernel memory of the computer, and detecting a sequence comprises:
placing a callback function in the kernel memory; and
triggering execution of the callback function upon an occurrence of an event caused by the call to the system function.

11. The method according to claim 10, further comprising placing a hook on the system function in kernel memory.

12. The method according to claim 10, further comprising registering the callback function with a kernel that executes in the kernel memory.

13. The method according to claim 1, further comprising the steps of:
profiling activities of the computer by recording other sequences of function calls thereof; and
accumulating the other sequences in the database.

14. A computer software product for including a non-transitory computer-readable storage medium in which computer program instructions are stored, which instructions, when executed by a computer, cause the computer to perform the steps of:
a150| detecting a sequence of function calls in a memory space of a process executing on the computer, the sequence having members;
searching for the sequence in a database of non-malicious function calls;
failing to locate one of the members in the database; and
responsively to failing to locate reporting an anomaly in the sequence.

15. The software product according to claim 14, wherein reporting an anomaly comprises causing at least one of: an inactivation or a termination of the process, an inactivation or termination of a thread of the process; and a blockage of an event caused by an execution of the process or the thread.

16. The software product according to claim 14, wherein searching for the sequence comprises tracing a stack of the process to identify the members of the sequence therein.

17. The software product according to claim 16, wherein tracing the stack comprises identifying respective return addresses in frames of the stack, and failing to locate comprises determining that that the return address in one of the frames is anomalous.

18. The software product according to claim 16, tracing the stack comprises identifying an order of the function calls in the sequence and failing to locate comprises determining that the order is anomalous.

19. The software product according to claim 14, wherein detecting a sequence comprises placing a hook onto a called function of the sequence and inserting stack analysis code into the computer, wherein the stack analysis code is activated by the hook.

20. The software product according to claim 14, wherein the sequence of function calls comprises a call to a system function that executes in a kernel memory of the computer, and detecting a sequence comprises:
placing a callback function in the kernel memory; and
triggering execution of the callback function upon an occurrence of an event caused by the call to the system function.

21. The software product according to claim 20, wherein the computer is further instructed to perform the step of placing a hook on the system function in kernel memory.

22. The software product according to claim 20, further comprising registering the callback function with a kernel that executes in the kernel memory.

23. A data processing system, comprising:
a processor;
a database of non-malicious function calls
a memory including a user memory and a kernel memory, the memory being accessible to the processor storing programs and data objects therein, the programs including a code injection module, a stack trace module, a stack analysis module and a policy control module, wherein execution of the programs cause the processor to perform the steps of:
invoking the code injection module to place detection code in one of the kernel memory and the user memory;
executing the detection code to detect a sequence of function calls in a memory space of a process;
invoking the stack trace module to unwind the sequence of function calls;
invoking the analysis module to search for members of the sequence of function calls in the database;
failing to locate one of the members of the sequence in the database; and
responsively to failing to locate invoking the policy control module to report an anomaly in the sequence.
